(19) United States
(12) Patent Application Publication
(10) Pub. No.: US 2024/0388652 A1
(43) Pub. Date: Nov. 21, 2024

(54) METHOD AND SYSTEM FOR COMMUNICATION VIA A CELLUAR COMMUNICATION DEVICE VIA A SECURE USER INTERFACE

(71) Applicant: CONCERAS, LLC., Fairfax, VA (US)

(72) Inventor: Joseph Cole, Box Elder, SD (US)

(21) Appl. No.: 18/660,488

(22) Filed: May 10, 2024

Related U.S. Application Data
(63) Continuation-in-part of application No. 18/199,234, filed on May 18, 2023.
(60) Provisional application No. 63/622,395, filed on Jan. 18, 2024.

(51) Int. Cl. H04M 1/72454; H04M 1/72409; H04M 1/72463

(52) U.S. Cl. CPC H04M 1/72454; H04M 1/72409; H04M 1/72463

(57) ABSTRACT

Methods, devices and systems allow a user to utilize their cellular or WiFi communication device from within a secure area, preferably via a secure user interface that is communicatively coupled to their device which is located outside of the secure area. The system includes a communication interface located outside of the secure area which serves as an interface to the user communication device, and which communicates with a secure user interface within the secure user interface by one or more communication isolators that transmit information between the secure and unsecure areas via optical communication signals. The secure user interface includes secure user input and/or out devices such as a touch screen display, speaker, microphone and keyboard for presenting outputs and receiving inputs in a manner that mimics direct interaction with the user communication device.

### RELATED APPLICATION DATA

This application claims priority to U.S. Provisional Patent Application Ser. No. 63/622,395, filed Jan. 18, 2024, and is a continuation-in-part of U.S. application Ser. No. 18/199,234, filed May 18, 2023. The present application incorporates by reference each of said prior applications as if set forth fully herein.

### FIELD OF THE INVENTION

The present invention relates to communication devices and systems, and in particular those which include the use of wireless devices in association with secure spaces.

### BACKGROUND OF THE INVENTION

With cell phones becoming ubiquitous in our everyday lives, a unique problem arises in the Military and Government sector where cell phones are not allowed in controlled or secure spaces where secure (proprietary, classified, etc.) information is processes and discussed. These restrictions limited a person's ability to function at the workplace, in that most employees heavily rely on their cell phones because they store important information (contacts lists, photographs, etc.), serve as a communication interface for calls, texts and emails, VOIP telco, social media communications applications such as WhatsAPP, FaceBook Messager, and operate important applications such as home security interfaces, web browsers, etc. Similar restrictions may even be imposed in the civilian space, such as in sensitive areas where protection of trade secrets and other highly confidential information is desirable.

Generating a solution to address the problems that are created because a user's cell phone can't be brough into such a secure area is, however, difficult. This is in part because of the numerous security-related requirements and objectives which prevent a user from bringing their phone into the secure space.

For example, for security purposes, no device which emanates a radio frequency (RF) signal is allowed into controlled spaces-which includes not only cellular signals, but WiFi, Bluetooth, near field (NF) and other RF technologies. This prevents, for example, a solution in which the user leaves their phone outside of the secure space but then links to it from a device within the space via such wireless protocols.

A user is also prevented from bringing their phone into such a space because the phone could potentially be tampered with to include a separate device “bug” to send a signal outside the controlled space. Thus, the user's phone can't be brought into the space even if the wireless communications thereof are not utilized-effectively removing the ability to utilize any device in the secure space which can communicate wirelessly.

Communications signaling via wired (e.g. copper) connection outside these spaces are also forbidden as it creates a security issue in that it could potentially acts as an antenna to shunt a radiated signal intended to remain in the secure area and providing a means of sending that signal out.

Communication devices contained within these controlled workspaces must also be secured relative to the user interface features thereof. For example, no cameras are allowed in these space, and measures must be taken to ensure the microphone and or speaker of any device can't be accessed to remotely eavesdrop on the secure space.

A solution to these problems is desired.

### SUMMARY OF THE INVENTION

Aspects of the invention comprise methods, devices and systems which allow a user to utilize their cellular communication device from within a secure area, via a secure user interface that is communicatively coupled to their device which is located outside of the secure area via an isolated methodology.

One embodiment of the invention comprises a system facilitating secure communications with a user communication device from a secure area comprising: a secure storage element for location in an unsecure area, the secure storage element comprising a compartment for receiving a user communication device, the compartment defining a lockable interior space and permitting wireless communications from the interior space to an exterior thereof; a communication device interface for location in the unsecure area, the communication interface comprising a first wired communication port for connection to a wired communication port of the user communication device, a wireless communication interface for communicative coupling to a wireless communication interface of the user communication device, and at least one second communication port, the communication device interface configured to receive, via at least one of the first wired communication port and wireless communication interface, a video output an audio output of the user communication device and to output at least one signal representative thereof via the at least one second communication port; a first communication isolator for location in the unsecure area, the first communication isolator comprising at least one first communication port for connection to the at least one second communication port of the communication device interface for receiving the at least one signal representing the video output and audio output of the user communication device, and at least one optical communication port; a second communication isolator for location in the secure area, the second communication isolator comprising at least one optical communication port for connection to the at least one optical communication port of the first communication port to permit digital optical communications between the first and second communication isolators via an optical communications channel, and at least one secure user interface communication port; and a secure user interface for location in the secure area, the secure user interface comprising at least one communication port for connection to the at least one secure user interface communication port of the second communication isolator, the secure user interface comprising one or more user interface devices configured to present the video and audio output of the user communication device and to receive user input for input to the user communication device; whereby a user within the secure area may securely communicate with their user communication outside in the unsecure area via the secure user interface, including providing inputs to the user communication device and receiving outputs therefrom.

A method of facilitating secure communications to and from a user in a secure area via an unsecured user communication device comprising the steps of: receiving a user communication device in a secure compartment of a secure storage element in an unsecure area; receiving a video output and an audio output of the user communication device at a communication device interface in the unsecure area; communicatively coupling an output of the communication device interface with an input of a first communication isolator in the unsecure area; converting, by the first communication isolator, the electrical signal output to a digital optical signal output; transmitting, from the first communication isolator to a second communication isolator located in the secure area, digital optical signal output; converting, by the second communication isolator, the digital optical signal output to at least one electrical signal output; and transmitting, from the second communication isolator to a secure user interface located in the secure area, the at least one electrical signal output; causing at least one secure presentation device to present the information in response to the at least one electrical signal output.

In one configuration, optical signals can be separated or multiplexed. The secure storage element may comprise a locker, such as which has a plurality of lockable compartments.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system of the invention;

FIG. 2 illustrates an embodiment of a secure user interface of a system of the invention;

FIG. 3 illustrates an embodiment of a portion of the secure user interface illustrated in FIG. 2;

FIG. 4 illustrates another embodiment of a portion of the secure user interface illustrated in FIG. 2;

FIG. 5 illustrates an example implementation of the portion of the secure user interface illustrated in FIG. 4;

FIG. 6 illustrates another embodiment of a system of the invention; and

FIGS. 7A and 7B illustrate yet another embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise methods, devices and systems that allow a user in a secure area to access one or more communication or computing devices in an unsecure area. In one embodiment, the communication device comprises a user's mobile (e.g. with wireless communication capability such as cellular, WiFi, etc.) communication device and the method and method permit a user to access their communication device from within a secure area, preferably via a secure user interface that is communicatively coupled to their device which is located outside of the secure area.

As used herein, the term “secure area” or “controlled area” may be any area in which there are restrictions on the use of communication devices, such as cellular phones. As noted above, such areas might comprise military or government installations or other areas where the laws and regulations regarding the security of information apply. These areas might also comprise, however, sensitive areas of corporate offices or manufacturing plants, etc.

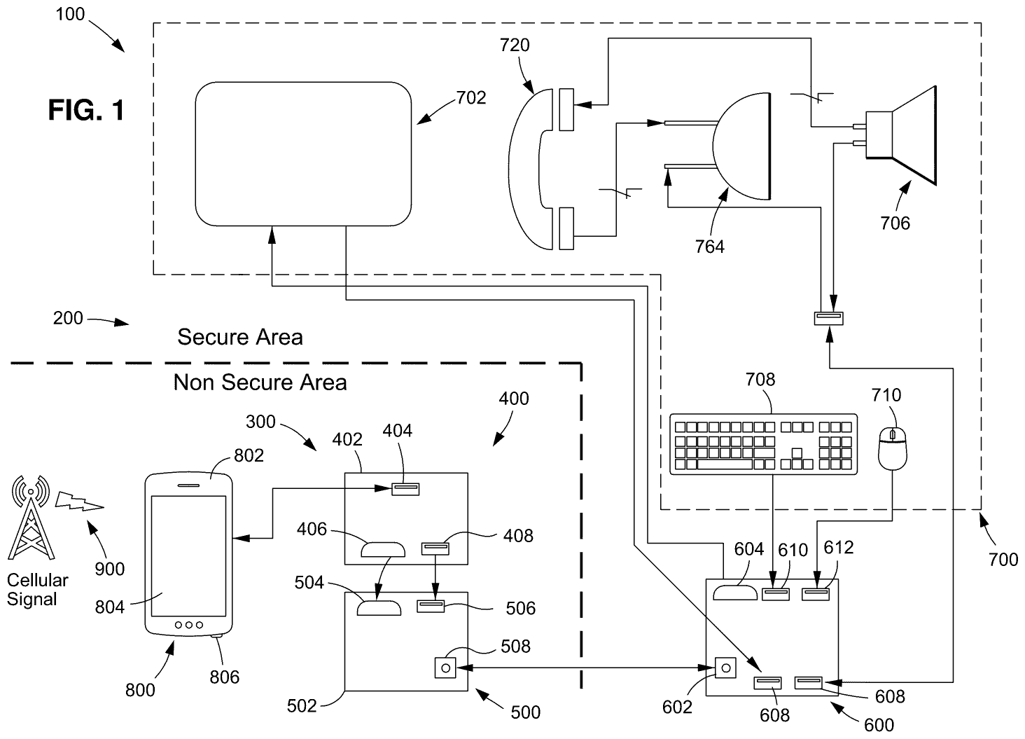

One embodiment of the invention will be described with reference to FIG. 1. FIG. 1 illustrates one example of a system 100. The system 100 includes components which are located within a secure area 200 and includes components which are located outside of the secure area, which area may be referred to as a non-secure area 300. As indicated above, the type and location of the secure area 200 may vary, and might comprise a government building, military installation, corporate office, etc. The non-secure area 300 may comprise a public space or a private space, such as a portion of the government building, military installation, corporate office or the like which is outside of the secure area 200 (and not within another secure area).

In one example, the system 100 comprises a communication device interface 400, a first communication isolator 500, a second communication isolator 600, and a secure user interface 700.

In a preferred embodiment, the communication device interface 400 comprises a communication interface to a user communication device 800. As described below, in use, the user communication device 800 is located in the non-secure area 300. The communication device interface 400 is thus also located in this same area.

The user communication device 800 may comprise, for example, a cell phone, PDA, tablet or the like which supports communication functionality. The user communication device 800 may include a housing 802, processor, a memory, machine-readable code stored in the memory and executable by the processor (such as in the form of downloaded or installed “applications”), one or more user input devices (such as a touch screen, button(s), microphone, etc.), an information display 804 (such as at least one video display) and one or more peripheral devices, such as a camera, gyroscope, speaker, altimeter, GPS unit, etc.

Moreover, the user communication device 800 includes at least one communication interface. The at least one communication interface preferably supports wireless communications, preferably over at least a cellular network 900, and may permit other forms of communication, such as Wi-Fi, Bluetooth, near field (NF) and other forms of wireless communication, plus wired communications. Such wired communications may be, for example, via a port 806. The configuration of the port 806 might vary, such as depending upon the communication device 800. For example, the port 806 might comprise an Apple® Lightning™ connection port, a USB Type A, Type C, Mini B, Micro B, Micro B Super Speed, ports of other configurations now known or later developed for establishing a wired communication link. The user communication device 800 may comprise, for example, an Apple® iPhone™ device, an Android™-based communication device such as a Samsung® Galaxy™, a Motorola® Razor™, or various other communication devices now known or later developed and which may be produced or provided by various manufacturers. In this regard, the present invention is not limited to any particular device, or the devices manufactured by a particular manufacturer.

In one embodiment, the communication device interface 400 comprises a housing 402, and one or more communication interfaces, such as input/output (I/O) ports. For example, the communication device interface 400 may include at least a first I/O port 404 which serves as a communication interface to the user communication device 800. The configuration of the first I/O port 404 may depend upon the configuration of the wired port of the user communication device 800, but in one embodiment, may comprise a USB type C or type A port. In such a configuration, for example, when the user communication device 800 comprises an Apple® iPhone™, a communication cable having an Apple® Lightning™ male connector may be plugged into the communication port 806 of the communication device, and a USB type A or C connector at the opposing end of the cable may be plugged into the first I/O port 404 of the communication device interface 400. Again, it will be appreciated that the configuration of the first I/O port 404 may vary, such as depending upon the configuration of the desired wired communication link between it and the user communication device 800. Further, while in a preferred embodiment, a wired connection, such as a cable, is used to connect the user communication device 800 to the communication device interface 400, other types of direct connections may be used (in some instance, wireless communications may be used if entirely in the secure area). For example, in one configuration, the communication device interface 400 might be configured as a cradle, such as where the I/O port 404 is configured as a male connector that fits directly into the communication port 806 of the user communication device 800. Further, in some embodiments, assuming such is supported by the user communication device 800, even a wireless communication link might be provided between it and the communication device interface 400 (e.g. such as a Wi-Fi connection). In one example embodiment, the communication device interface 400 may facilitate a “casting” function of the user communication device 800. Such a function, which can be facilitated by the AirPlay™ function of an Apple® iPhone™, or is also known as Google® Chromecast™, allows transmission of the video displayed by a user communication device 800 (and associated audio) via a Wi-Fi connection, such as to a wireless communication interface of the communication device interface 400 (or, when functionality of communication device interface 400 is integrated with a first communication isolator 500, as detailed below, to an interface thereof).

The communication device interface 400 preferably also includes other I/O ports, preferably serving as at least one communication interface with the first communication isolator 500. For example, the communication device interface 400 may include a second I/O port 406 and a third I/O port 408. In one preferred embodiment, the second I/O port 406 comprise an interface for visual signals or information and the third I/O port 408 may comprise an interface for other types of data. In such a configuration, the communication device interface 400 may include one or more splitters, processors or the like for separating such information as received from the user communication device 800 and/or for assembling such information (from the first communication isolator 500) for transmission thereto. For example, the second I/O port might comprise an HDMI (or DVI or similar) port, while the third I/O port 408 data might comprise a USB port, such as a USB Type A port.

In some embodiments, the communication device interface 400 is configured to interface with a plurality of different user devices. In such a configuration, the communication interface 400 may be configured as a hub, having multiple I/O ports 404 for connection to different user communication devices 800 and which connect to the one more I/O ports which serve as interfaces to the first communication isolator 500.

As described below, the communication device interface 400 communicates with the first communication isolator 500. The first communication isolator 500 is also located in the non-secure area 300.

In one embodiment, the first communication isolator 500 comprises a housing 502, one or more communication interfaces or ports for communicating with the communication device interface 400, and one or more communication interfaces or ports for communicating with the second communication isolator 600 (preferably, as described below, via optical communications).

At least one first I/O port is preferably configured to serve as a communication interface with the communication device interface 400. This may comprise a first I/O port 504 and a second I/O port 506. For example, where one of the I/O ports 406 of the communication device interface 400 is a video port (such as an HDMI port), the first I/O port 504 of the first communication isolator 500 may comprise an HDMI input port. Similarly, where another of the I/O ports 408 of the communication interface 400 comprises a USB port, the second I/O port 506 of the first communication isolator 500 may include a corresponding USB port.

Preferably, the communication device interface 400 is communicatively coupled to the first communication isolator 500. For example, an HDMI cable may be placed in communication with the HDMI port 406 of the communication device interface 400 and the HDMI port 504 of the first communication isolator 500.

Most importantly, the first communication isolator 500 is configured to convert signals input thereto from the communication device interface 500 into a non-radio frequency or electrical signal, such as preferably a digital optic signal for transmission to the second communication isolator 600, and to receive such non-radio frequency signals (e.g. digital optical signals) from the second communication isolator 600 and convert them back for transmission to the communication device interface 500. This may be accomplished, for example, by one or more signal processors of the first communication isolator 500. In this configuration, the first communication isolator 500 has at least one I/O port 508 which comprises a communication interface with the second communication isolator 600. Preferably, this comprises a third I/O port 508 which comprises an optical port, such as in the form of a fiber optic cable port.

The output from the first communication isolator 500 is provided to a first I/O port 602 of the second communication isolator 600 which is located in the secure area 200. When the input is a digital optical signal, the first I/O port 602 is preferably an optical port.

Most importantly, the second communication isolator 600 is configured to process and direct incoming signals to the secure user interface 700. As described below, the second communication isolator 600 is also configured to receive signals, such as inputs, from the secure user interface 700 for routing back to the first communication isolator 500 and thereon to the user's communication device 800, via the first I/O port 602 thereof as connected to the third I/O port 508 of the first communication isolator 500.

In one preferred embodiment, the secure user interface 700 comprises a plurality of secure input and output devices. In a preferred embodiment, the secure user interface 700 is configured to effectively serve as a secure extension of the user communication device 800—such as by mimicking outputs and inputs that could be provided directly thereto, but permits such to occur relative to a user who is remote from their device. In one embodiment, these devices comprise a touch-screen display 702 which is configured to display information and receive touch inputs from the user, an audio input device such as a microphone 704, an audio output device such as a speaker 706, and in one example, one or more tactile input devices such as a keyboard 708 and a mouse or mouse pad 710.

The touch-screen display 702 is configured to receive a video input from the second communication isolator 600, such as via a video port 604. This port 604 might comprise, for example, an HDMI, DVI or other video port. An HDMI cable or the like may connect the video output port 604 of the second communication isolator 600 to the touch-screen display 702. In one example, the user inputs to the touch-screen display 702 are input to the second communication isolator 600, such as to a first input port 609 thereof. This input port 609 might comprise, for example, a USB port for touch screen capability. In one example, a USB cable which has a 2.0 Micro connector at one end and a USB Type A connector at the other may be utilized between the touch-screen display 702 and the second communication isolator 600, whereby the second communication isolator 600 provides power and touch screen input to the touch-screen display 702.

In a preferred configuration, the touch-screen display 702 does not include additional functionality such as audio in (such as via a microphone), audio out (such as via a speaker), or video in (such as via a camera). Most preferably, this functionality is preferably provided by separate devices having security features as described below.

In one example, audio signals which are received by the second communication isolator 600 are processed and routed to an I/O port 608 which is communicatively coupled to the speaker 706 and microphone 704, such as via a USB 2.0 Type A cable or USB 3.0 Type A depending on the distant end device 800. Audio inputs from the user are captured by the microphone 704 and are routed to the I/O port 608 of the second communication isolator 600.

User inputs to the keyboard 708 are output therefrom to a second input port 610 of the second communication isolator 600, and user inputs to the mouse 710 are output therefrom to a third input port 612 of the second communication isolator 600. These ports might comprise, for example, USB Type A ports for accepting a corresponding connector of a USB cable.

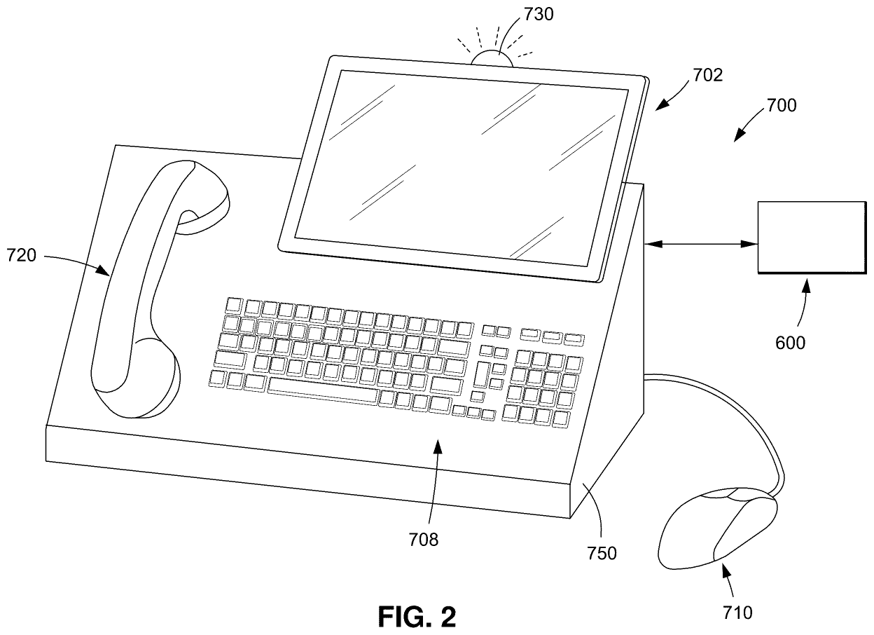

Referring to FIG. 2, in one embodiment, the microphone 704 and speaker 706 may be integrated, such as into a handset 720. Further, as illustrated in FIG. 2, the touch-screen display 702, the handset 720 and keyboard 708 might be integrated into (mounted or set on, connected to, etc.) a base 750 or the like, such as for ergonomics and convenience. In such a configuration, for example, the display 702 might be movably mounted to the base 750, such as to permit it to rotate to various positions (such as various angles of tilt in both the horizontal and vertical), etc. The keyboard 708 might be merely set upon a surface of the base, or it might be mounted into the base 750, such as where the keys extend through a top panel thereof or a keyboard may sit on the desk with the mouse.

In a preferred embodiment, although not shown in detail, power supplies which are used to power the devices in the secure area 200 are isolated from those used to power the devices in the non-secure area 300. Power separation between electrical systems in non-secure area 300 and secure area 200 is preferable. For example, the communication device interface 400 and first communication isolator 500 are preferably powered by one or more first power supplies which are associated with the non-secure area 300. On the other hand, the second communication isolator 600 and the elements of the secure user interface 700 are preferably separately powered, preferably associated with the secure area 200.

General operation of the system 100 will now be described with reference to FIG. 1. A user connects their user communication device 800 to the communication device interface 400 in the non-secure area 300. The user may then enter the secure area 200 without their user communication device 800.

The output of the user communication device 800 is connected to the communication device interface 400, which is in turn routed to the first communication isolator 500 to the second communication isolator 600. The video output of the user communication device 800 is displayed by the touch-screen display 702 and any audio output is output by the speaker 706. In this manner, although the user is located in the secure area 200 and the user communication device 800 is located in the non-secure area 300, the user can see the “display” (e.g. the content which is displayed by) of their device just as if they were looking directly at the video display 804 thereof, and can hear any audio output, such as if they were directly hearing the audio output thereof.

At the same time, the user can interact with their user communication device 800 from within the secure area 200. For example, the user can make touch inputs to the touch-screen display 702 which are routed to the user communication device 800 and provided thereto just as if the user had provided the inputs directly to the display 804 thereof. Further, the user may make other inputs, such as audio inputs via the microphone 704 and/or mouse or keyboard inputs to the mouse 710 and keyboard 708. These inputs are routed through the second communication isolator 600 to the first communication isolator 500 and thereon to the user communication device 800, just as if they were being provided directly to the device 800.

In such a configuration, for example, a user may make and receive telephone calls, read and send text messages, read and send emails, run applications and receive outputs from those applications and make inputs to those applications, etc. For example, a user may input their PIN into the touch-screen display 702 (which is then routed to their user communication device 800) in order to access text, phone, email or other applications and provide inputs thereto. The users communication device 800 remains in communication with cellular networks 900 or other networks (such as via Wi-Fi, etc.), such that the user communication device 800 still acts as digital terminal equipment (“DTE”) relative to such communication networks.

At the same time, the user communication device 800 is isolated from the secure area 200 in a manner which solves the problems which are described herein. In particular, the portion of the system 100 which is located in the secure area 200, including the second communication isolator 600 and the secure user interface 700, are components which do not emit wireless signals, such as radio frequency signals. Further, the user communication device 800 is located in the non-secure area 300, so any bugs or the like which might be associated therewith do not influence the secure area 200.

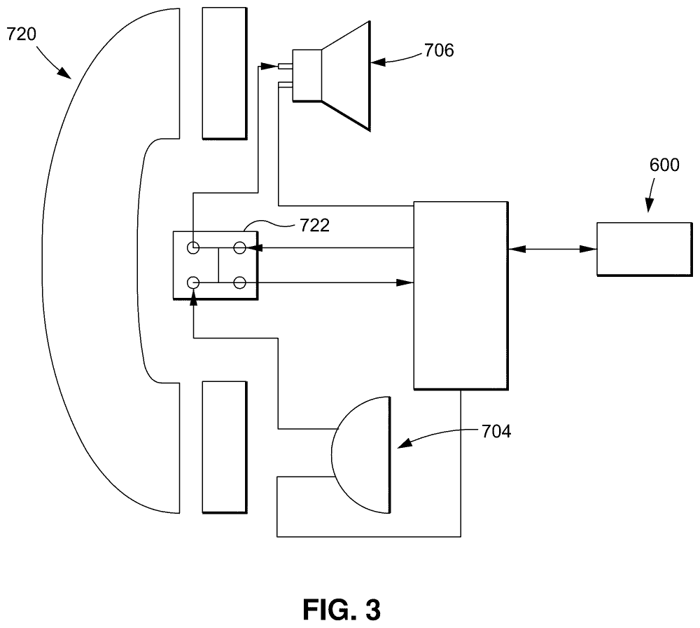

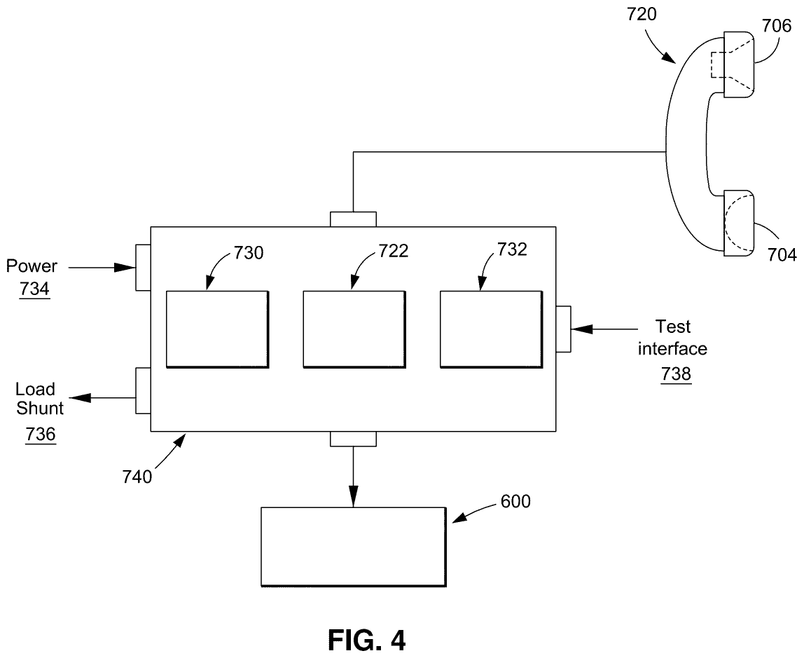

Additional aspects of the invention will be described with reference to FIGS. 3 and 4.

In one embodiment, the system 100 may include other security features. For example, in one configuration, means may be provided for positively connecting and disconnecting the microphone 704 and/or speaker 706.

As one example, as illustrated in FIG. 3, a switch 722 may be associated with the handset 720. This switch 722 may have a first position or mode in which the communication path way to the second communication isolator 600 is open or incomplete, wherein no communication signals pass between the speaker 704 and microphone 706 and the second communication isolator 600, and a second position or mode in which that communication pathway is closed or complete. In one embodiment, the switch 722 might be associated with the handset 720, such as having a portion on the handset 720 which can be manually actuated (such as pressed) to move it from the first position (such as biased to that position) to the second position. In this manner, when a user wishes to use the microphone 704 and/or speaker 706 portions of the secure user interface 700, the user must activate or engage the switch (such as by holding and depressing the switch during the time the user wishes to have the handset 720 be active), and preferably where that switch moves back to the first position when not engaged. This “positive engagement” aspect of the invention reduces the opportunity for the microphone and/or speaker to be used nefariously, such as to listen to sounds in the secure area 200 when it is not being used such as via hacking or bugging of the communications device 800.

Of course, this concept might be applied to other input or output devices of the secure user interface. In some embodiments, more than one switch might be provided, such as one corresponding to the microphone and one corresponding to the speaker.

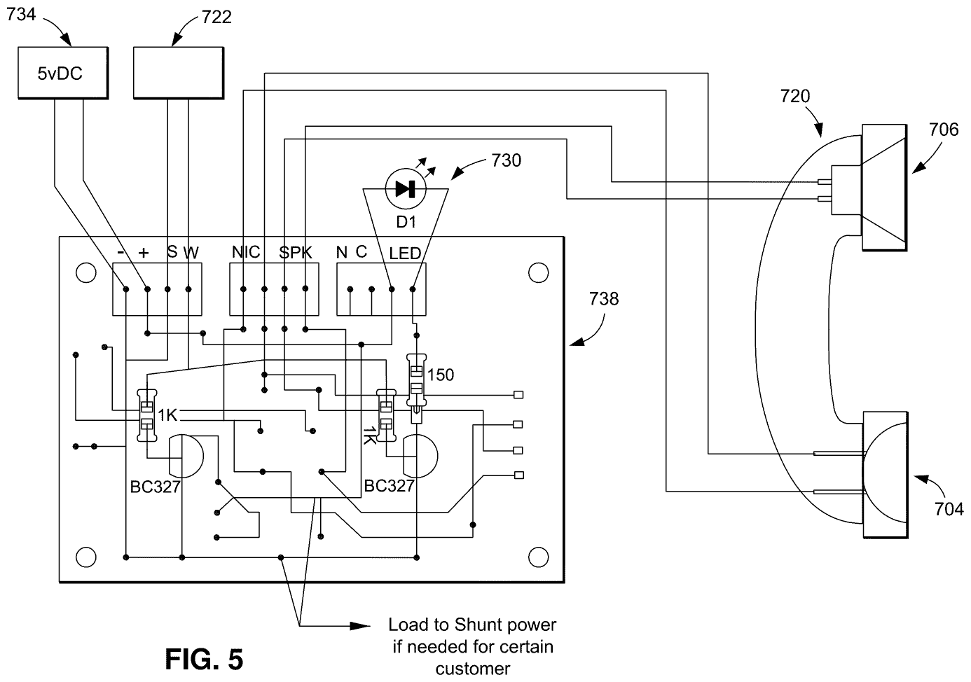

FIGS. 4 and 5 illustrates another configuration of the invention. As illustrated in FIG. 4, a handset module 740 may comprise the switch 722, one or more illumination devices or lights 730, and at least one audible emitter 732, such as a ringer or buzzer. This module 740 may be located between the handset 720 and the second communication isolator 600. The switch 722 may have similar functionality to that described above and might comprise a push-to-talk type button or switch. However, in another configuration, the switch 722 may be integrated into a base station or the like which accepts the handset 720 when not in use. When the handset 720 is not in use it may be placed on a portion of the switch 722 that causes the switch to move to an open position, thereby disconnecting the handset 720 from operation, and wherein when a user lifts the handset 720, the switch moves to a closed position, thereby rendering the handset 720 operable (e.g. placing it in communication with the second communication isolator 600) and lighting an LED “730” indicating it is off hook.

In one embodiment, the light 730 may illuminate to indicate when the handset 720 is operable. Thus, the light 730 may illuminate when the switch 722 is closed. As illustrated in FIG. 2, the light 730 may be associated with the base 750, such as by being located at an elevated or visible portion thereof, such as at the top of the display 702. In this manner, those in the vicinity of the secure user interface 700 can be visually warned when it is active.

In one embodiment, the buzzer or ringer 732, and/or one or more lights (such as the same as, or different from the light 730 which is used to indicated whether the handset is in use) may be configured to activate when an incoming signal is received by the user communication device 800 and is routed to the second communication isolator 600, such as to alert a user of the secure user interface 700 that a call, text, email or other communication has been received by the user communication device 800 and may require a response.

As illustrated in FIG. 4, the handset module 740 may have a power input 734, and might include other features, such as a load shunt 736 and technical security test interface 738.

FIG. 5 illustrates one example implementation of the handset module 740, wherein elements of the module 740 are associated with a circuit board.

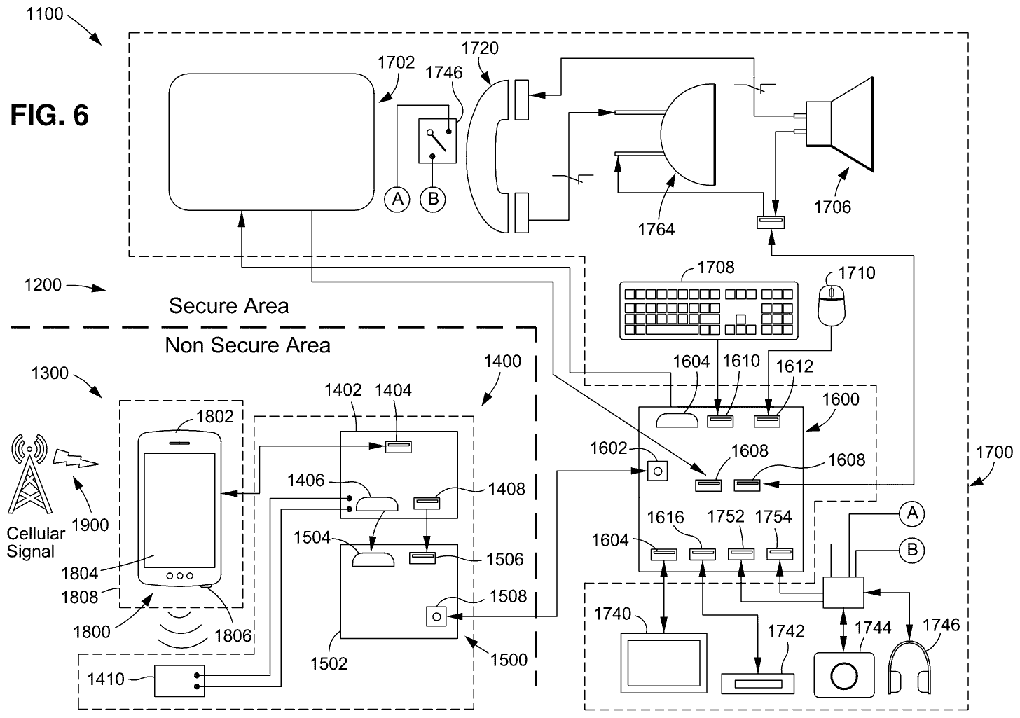

Additional aspects of the invention will be described with reference to FIG. 6. FIG. 6 illustrates another embodiment of a system 1100 which is similar to the system 100 described above and illustrated in FIG. 1, and wherein like elements have been given like reference numbers to the elements in FIG. 1. It will be appreciated that various features of this system 1100 might be implemented relative to the system 100 described above.

As illustrated in FIG. 6, as one aspect of the invention, the user communication device 1800 might be stored in a storage element 1808 within the non-secure area 1300. The storage element 1808 might comprise, for example, a container which has controlled access. For example, the container might define one or more storages areas, where each storage area is accessible via a door which may be lock controlled (such as via a mechanical lock such as which may be key-actuated, an electro-mechanical lock which might be controlled by a controller and motor, such as based upon input of an access code to a keypad or other device, etc.). The container might be constructed from a generally opaque material (such as Plexiglass, etc.) or the like to impede people from viewing the device in the non-secure area while active. Importantly, the storage element 1808 allows wireless communications with a user communication device 1800 which is associated therewith (e.g. is not constructed in a manner which causes it to interfere with, such as block, such signals).

In one embodiment, power may be provided to the one or more storage areas, such as via a charging port (such as a USB port, electrical outlet, USB cable or the like), thus allowing a user communication device 1800 which is stored in the storage area to be provided with power. In use, a user may open a storage area, connect their device to the data connection which also provides power, and place their device in communication with the communication device interface 1400, and then lock the storage area to protect their device from theft/loss, etc., such as while they are in the secure area 1200.

As indicated above, the communication device interface may be configured to communicate with the user communication device via a wireless communication link. In one embodiment, for example, the communication device interface 1400 may be configured to receive information/data from a wireless communication interface 1410 and be configured to transmit information/data thereto. The wireless communication interface 1410 may comprise, for example, a Bluetooth™ wireless communication interface which is configured to communicate with a similar interface of the user communication device 1800. In one embodiment, the wireless communication interface 1410 may be configured to convert the wireless signals received from the user communication device 1800 to a wired output, such as a 3.5 mm audio output which is provided to a mating port of the communication device interface 1400. Likewise, the communication device interface 1400 may include a similar audio output port over which audio may be transmitted to the wireless communication device interface 1410 for conversion to a wireless signal and transmission to the user communication device 1800. Of course, the wireless communication interface might be integrated into the communication device interface 1400. In other embodiments, the wireless communication interface 1410 might comprise a wireless communication dongle, such as which is plugged into a USB or other port of communication device interface 1400.

Once again, the information/data provided to the communication device interface 1400 from the wireless communication interface 1410 is preferably provided to the first communication isolator 1500, such as via corresponding communication ports, or via inclusion in other outputs of the communication device interface 1400 (such as via the signals which are output via the first or second I/O ports 1504, 1506, etc.). As described below, this arrangement facilitates communication to and from the user communication device 1800 when that device may output signals in different manners (such as via wired vs. wireless communications in different scenarios).

As further illustrated in FIG. 6, the secure user interface 1700 may include additional features. For example, the second communication isolator 1600 may include one or more additional video output (or I/O) ports 1604 (such as an HDMI, DVI port, etc.), such as for providing an additional video output therefrom (of the video portion of the signal/data received by the second communication isolator 1600 from the user communication device 1800) to a secondary video display (1740) (such as over an associated HDMI, DVI or other cable/communication link).

The secure user interface 1700 might also include other input and/or output ports, such as for receiving information from or providing information to, other devices. For example, the secure user interface 1700 might include a peripheral I/O port 1616, such as a USB port, for communication with a card reader device 1742, such as which may be configured to read a user identity or access card, including key data (such as a public or private access key) stored in association with the card (such as on a magnetic strip, chip, readable code, etc.).

In addition, the secure user interface 1700 may include one or more of an image capture device or camera 1744 and/or a headset 1746 (such as headphones and/or a microphone). An output of the camera 1744 may be provided to the second communication isolator 1600 via an input port 1752 (such as a USB port), and outputs to and inputs from the headset 1746 may be provided to and from the second communication isolator 1600 via an I/O port 1754 (such as a USB port; or via separate input and output ports).

In one configuration, a positive disconnect switch 1746 (similar to the switch 722 described relative to the handset 720 in FIG. 3), may be provided to selectively enable and disable operation of the camera 1744 and/or headset 1746. An input to the camera 1744 (such as an image of a user's face) may be utilized, for example, as an input to the user's communication device 1800 in order to validate the user and use of the user's communication device 1800 and/or applications running thereon.

In one embodiment, the secure user interface 700/1700 may be configured to, or permit, transmission of an input to the user communication device 800/1800, which dictates the orientation of the information displayed by the user communication device, and thus on the one or more video displays of the secure user interface. For example, a user input or a circuit/control input may be implemented by the secure user interface 700/1700 to the user communication device 800/1800, such as to force the user communication device into “landscape” display mode, which then corresponding causes the information displayed thereby to be displayed in the same orientation on the one or more displays of the secure user interface 700/1700. In other embodiments, the secure user interface 700/1700 might include a “rotate” function which allows information which is output by the user communication device 800/1800 to be rotated into a desired orientation for display by the one or more video displays thereof.

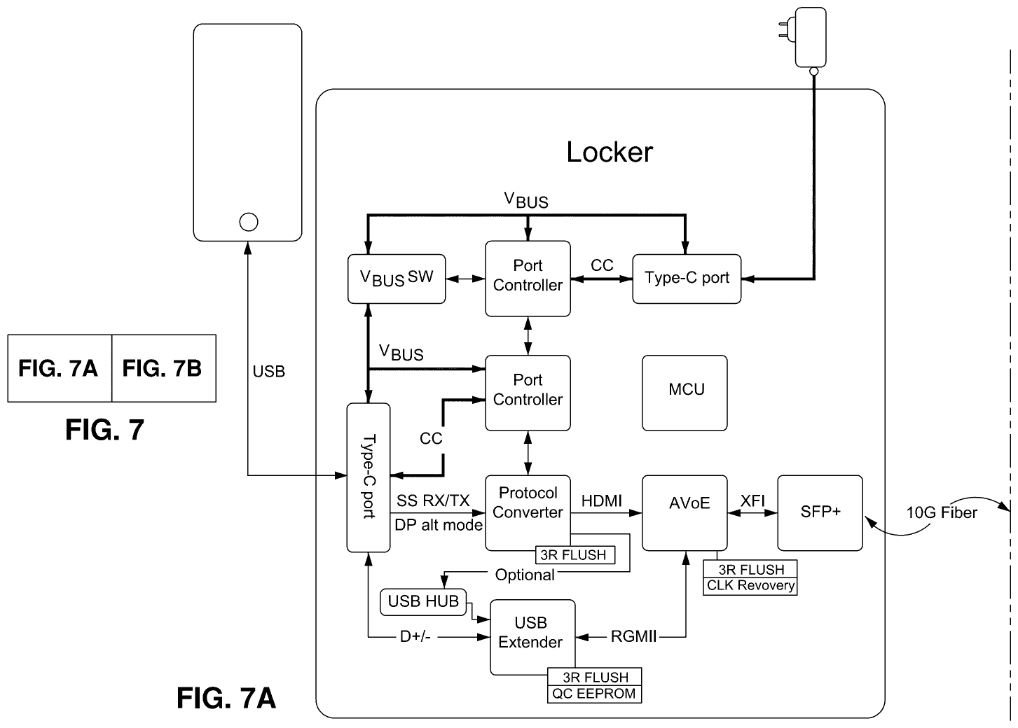

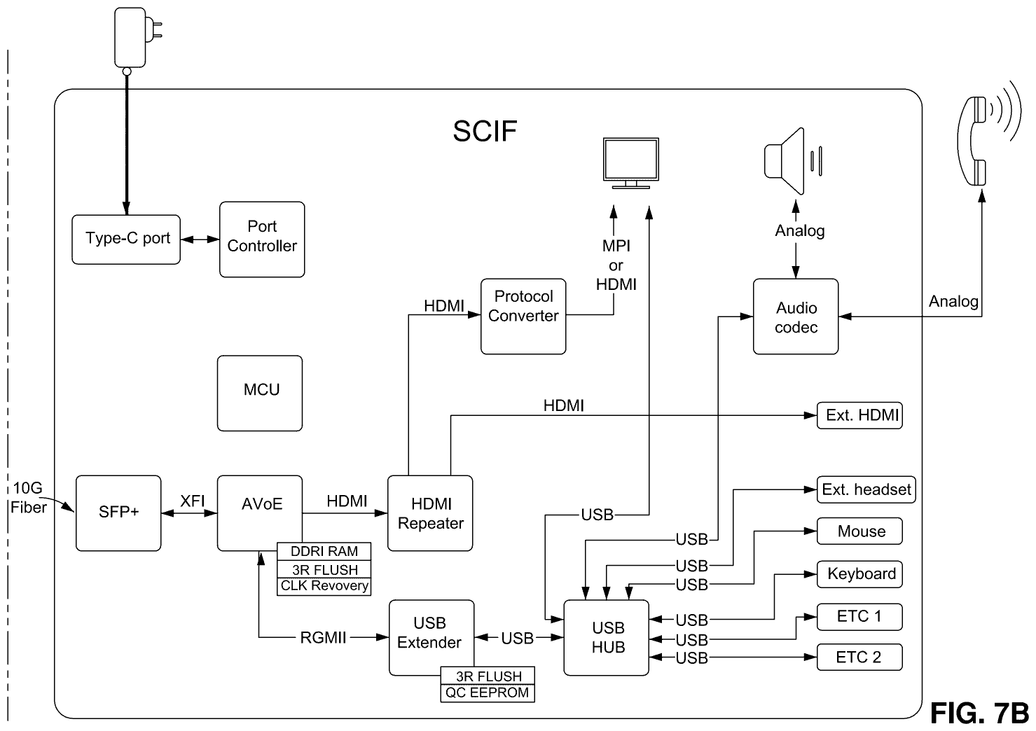

In examples of the invention, certain configurations and combinations of communication ports or interfaces have been described. It will be appreciated that other configurations or combinations of such ports/interfaces might be utilized. For example, instead of the first communication isolator 500/1500 and second communication isolator 600/1600 communicating via connected I/O optical ports, the first and second communication isolators 500/1500, 600/1600 might each have one optical output port and one optical input port, where by the input and output interfaces are separated. In general, different numbers of ports or interfaces might be utilized, such as depending upon whether signals are combined or separately transmitted or by the manufactured configuration of the communications device 800/1800. FIGS. 7A and 7B illustrate one example implementation of the invention. FIG. 7A illustrates a storage element (such as in the form of a locker having a plurality of lockable storage locations) for a plurality of user communication devices, where that storage element has an integrated communication device interface and first communication isolator, such as for location in an unsecure area. FIG. 7B illustrates a secure user interface (SCIF) for location in a secure area, which includes a second communication isolator (which is in communication with the first communication isolator illustrated in FIG. 7A) and which includes a plurality of secure user input and output devices. It will be appreciated from FIGS. 7A and 7B that many particular implementations of the present invention may be enabled.

In addition, the invention may be configured to not only isolate a user's cellular communication device (and enable secure communications therewith), but also enable secure communications with wired communication devices (such as traditional telephones) or voice over IP (VOIP) devices. For example, the communication device interface 400/1400 might include an RJ11, RJ45 and/or RJ12 interface for a telecommunication device cord and might transmit the signals provided thereover to the first communication isolator 500/1500 for processing and transmission to the second communication isolator 600/1600 (and vice versa, relative to signals provided from the second communication isolator 600/1600 to the first communication isolator 500/1500).

It will be appreciated that the invention might also serve as a secure computing interface, such as to remote computers, including servers hosting data or applications. In particular, elements of the secure user interface 700/1700, such as the keyboard, mouse and display, effectively serve as user interfaces to such remote devices. For example, the communication device interface 400/1400 might further include an RJ45 or similar port for an associated cable, such as for receiving and transmitting digital data, such as to a remote computer, such as via a network (LAN/WAN), the Internet or the like.

As another example, the communication device interface 400/1400 and first communication isolator 500/1500 might be integrated, such as into a single unit. In such a configuration, the functionality thereof may be combined. As one example, in such a configuration, the first I/O port 404/1404 of the communication device interface 400/1400 might comprise a first I/O port to a single module, where inputs thereto are processed and transmitted to an optical I/O port that is connected to the second communication isolator 600/1600 (so that the intermediate connections between the communication device interface 400/1400 and the first communication isolator 500/1500 are effectively eliminated, such as by integration).

One advantage to the configuration illustrated in FIG. 6 is that it facilitates use of devices where the source of the audio may result in a different output for the audio or a combination of two separate voice channels on the same device. For example, some user communication devices 800/1800 process audio differently, depending upon the source of the audio. For example, in some configurations, a user communications device 800/1800 may output audio via a wired output (such as the wired Lightning™ port of Apple® devices) and via a wireless (such as via Bluetooth™) interface. The configuration illustrated in FIG. 6 and as described above, is compatible with such a configuration, in that when the audio is output via the wired port, the audio and any associated video may be captured and routed to the first I/O port 1404, whereas when the audio is output via the wireless interface, the audio may be captured by the wireless interface 1410 and routed to the communication device interface 1400 and any video may be captured via the wired interface and also routed to the communication device interface 1400 (and vice versa).

In addition, the invention permits a wide range of user devices, such as a smart phones having different configurations and operating systems, which are located in the non-secure area, to be connected through mirroring technology to wirelessly transmit video and/or audio (such as via a wireless interface, such as a dongle, as described above), via the first and second communication isolators to a user interface in a secure area. In such a configuration, other inputs and outputs between the user device in the non-secure area and the user interface in the secure area (such as keyboard, mouse and other inputs) can be exchange via wired connections which are exchanged through the communication isolators.

Additional aspects of the invention comprise methods of facilitating secure communications to and from a user in a secure area, including but not limited to methods of utilizing a system of the invention.

In one embodiment, a method of facilitating secure communications to a user in a secure area via an unsecured user communication device is provided. In accordance with the method, at least one output of a user communication device located outside of the secure area is received. This output may comprise a wired or wireless output comprising video, audio and/or other data. In one embodiment, this step may comprise communicatively linking the user communication device with a communication interface, such as via one or more wireless and/or wired communication links.

In accordance with the method, electrical signals comprising the output of the user communication device are converted to one or more optical signals outside of the secure area, such as via a first communication isolator located outside of the secure area.

The one or more optical signals are transmitted from outside of the secure area to inside of the secure area, such as via one or more optical transmission paths, such as optical fiber. The one or more optical signals are converted to one or more input signals to one or more user devices of a secure user interface, such as via a second communication isolator located in the secure area. The one or more input signals are used to present audio, visual or other information to the user via the devices of the secure user interface, such as video information on a video display and audio information via a handset or speaker.

Another embodiment of a method of the invention comprises facilitating secure communications from a user in a secure area via an unsecured user communication device. In accordance with the method, inputs are received from the user in the secure area to one or more user input devices of a secure communication interface. These inputs may comprise, for example, inputs to a keyboard, touch screen, camera, microphone, card reader or the like. These user inputs are converted to optical signals in the secure area, such as at a second communication isolator, and are then transmitted from the secure area to an unsecure area, such as via one or more optical communication paths to a first communication isolator in the unsecure area. The one or more optical signals are then converted to electrical signals and are provided to a user communication device. In one embodiment, the first communication isolator converts the optical signals to one or more electrical signals, outputs those one or more signals to a communication interface in the unsecured area, and then further outputting those signals from the communication interface to the user communication device, such as via one or more wired or wireless communication interfaces.

Additional aspects of the method may comprise disconnecting one or more elements of the secure communication interface when not in use, such as disconnecting them from the second communication isolator. In one embodiment, one or more alerts, such as visual or audio, may be indicated in the secure area in response to an incoming communication from the user communication device.

Aspects of the method apply to communications to and/or from a user in a secure area with devices other than a user wireless communication device, such as a computing device, telephone or other communications or computing device which is located in an unsecure area.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system facilitating secure communications with a user communication device from a secure area comprising:
a secure storage element for location in an unsecure area, said secure storage element comprising a compartment for receiving a user communication device, said compartment defining a lockable interior space and permitting wireless communications from said interior space to an exterior thereof;
a communication device interface for location in said unsecure area, said communication interface comprising a first wired communication port for connection to a wired communication port of said user communication device, a wireless communication interface for communicative coupling to a wireless communication interface of said user communication device, and at least one second communication port, said communication device interface configured to receive, via at least one of said first wired communication port and wireless communication interface, a video output an audio output of said user communication device and to output at least one signal representative thereof via said at least one second communication port;
a first communication isolator for location in said unsecure area, said first communication isolator comprising at least one first communication port for connection to said at least one second communication port of said communication device interface for receiving said at least one signal representing said video output and audio output of said user communication device, and at least one optical communication port;
a second communication isolator for location in said secure area, said second communication isolator comprising at least one optical communication port for connection to said at least one optical communication port of said first communication port to permit digital optical communications between said first and second communication isolators via an optical communications channel, and at least one secure user interface communication port; and
a secure user interface for location in said secure area, said secure user interface comprising at least one communication port for connection to said at least one secure user interface communication port of said second communication isolator, said secure user interface comprising one or more user interface devices configured to present said video and audio output of said user communication device and to receive user input for input to said user communication device;
whereby a user within said secure area may securely communicate with their user communication outside in said unsecure area via said secure user interface, including providing inputs to the user communication device and receiving outputs therefrom.

2. The system in accordance with claim 1, wherein said user interface devices of said secure user interface comprise a video display having touch input, at least one speaker and at least one microphone.

3. The system in accordance with claim 2, wherein said user interface devices of said secure user interface further comprise at least one of a secondary video display, a camera, a card reader and a headset.

4. The system in accordance with claim 2, further comprising at least one switch for connecting and disconnecting said camera and headset from said second communication isolator.

5. The system in accordance with claim 1, wherein said wireless communication interface of said communication device interface facilitates Bluetooth™ connectivity with said user communication interface.

6. The system in accordance with claim 1, wherein said secure storage element comprises a locker having a plurality of lockable compartments.

7. The system in accordance with claim 1, wherein said at least one second communication port of said communication device interface and said at least one first communication port of said first communication isolator each comprise an HDMI port.

8. The system in accordance with claim 1, wherein said at least one second communication port of said communication device interface comprises an HDMI and a USB port and said at least one first communication port of said first communication isolator comprises an HDMI and a USB port.

9. The system in accordance with claim 1, wherein said at least one speaker and said at least one microphone are associated with a handset having a positive disconnect.

10. The system in accordance with claim 1, wherein said secure user interface further comprises at least one indicator which is activated in response to an incoming communication received by said secure communication interface.

11. The system in accordance with claim 10, wherein said at least one indicator comprises at least one of a light and a buzzer.

12. The system in accordance with claim 1, wherein said user communication device comprises a mobile phone having wireless communication capabilities.

13. A method of facilitating secure communications with a user communication device from a secure area comprising:
receiving a user communication device in a secure compartment of a secure storage element in an unsecure area;
receiving a video output and an audio output of said user communication device at a communication device interface in said unsecure area;
communicatively coupling an output of said communication device interface with an input of a first communication isolator in said unsecure area;
converting, by said first communication isolator, said electrical signal output to a digital optical signal output;
transmitting, from said first communication isolator to a second communication isolator located in said secure area, digital optical signal output;
converting, by said second communication isolator, said digital optical signal output to at least one electrical signal output; and
transmitting, from said second communication isolator to a secure user interface located in said secure area, said at least one electrical signal output;
causing at least one secure presentation device to present said information in response to said at least one electrical signal output.

14. The method in accordance with claim 13, wherein said step of receiving said video output and said audio output comprise communicatively coupling said communication device interface to said user communication device via wired and wireless communication channels.

15. The method in accordance with claim 13, further comprising providing power to said user communication device in said secure compartment.

16. The method in accordance with claim 13, wherein said secure compartment permits wireless communications between an interior and an exterior thereof.

17. The method in accordance with claim 13, wherein said video output and said audio output represent at least one of a voice call and a text message.

18. The method in accordance with claim 13, wherein said at least one secure presentation device comprises a video display and a speaker.

19. The method in accordance with claim 13, further comprising the steps of:
receiving, at a user input device of said secure user interface, a user input;
outputting, from said secure user interface to said second communication isolator, an electrical signal based upon said user input;
converting, at said second communication isolator, said electrical signal to a second digital optical signal;
transmitting, from said second communication isolator to said first communication isolator, said second digital optical signal;
converting, at said first communication isolator, said second digital optical signal to an electrical signal;
transmitting said electrical signal from said first communication isolator to said communication device interface; and
transmitting, from said first communication device interface to said user communication device, an output based upon said electrical signal.

20. The method in accordance with claim 19, wherein said user input device comprises a touch screen associated with a video display and said output to said user communication device comprises an input to a touch screen of said user communication device.
